(19) United States
(12) Patent Application Publication
(10) Pub. No.: US 2026/0222400 A1
(43) Pub. Date: Jul. 30, 2026

(54) AUTHORIZATION METHOD

(71) Applicant: Beijing Xiaomi Mobile Software Co., Ltd., Beijing (CN)

(72) Inventors: Haoran LIANG, Beijing (CN); Wei LU, Beijing (CN)

(73) Assignee: Beijing Xiaomi Mobile Software Co., Ltd., Beijing (CN)

(21) Appl. No.: 19/145,717

(22) PCT Filed: Jan. 6, 2023
(86) PCT No.: PCT/CN2023/071120

§ 371 Date: Jul. 3, 2025

(51) Int. Cl. H04L 9/40

(52) U.S. Cl. CPC H04L 63/083; H04L 63/10

(57) ABSTRACT

The present disclosure provides an authorization method. The method is performed by an application function (AF), and includes sending token request information to an authorization function. The token request information is configured to request an access token, and the access token is configured to authorize the AF to manage a first resource.

### CROSS-REFERENCE TO RELATED APPLICATIONS

The present application is a U.S. National Stage of International Application No. PCT/CN2023/071120 filed on Jan. 6, 2023, the entire contents of which are incorporated herein by reference for all purposes.

### TECHNICAL FIELD

The present disclosure relates to, but is not limited to, the field of wireless communication technology, and in particular, relates to an authorization method and device, a communication device, and a storage medium.

### BACKGROUND

Certain resources within a core network can be managed by an application function (AF) through a network exposure function (NEF). For example, these resources may include quality of service (QoS) of personal IoT networks (PIN), connection information related to a PIN element and/or a user route selection policy (URSP) rule related to the PIN element, core network assistance information related to a specific terminal or the like. From a security point of view, the authorization of the request of the AF to manage a resource in the core network should be restricted to a specific authorized resource and needs to be subject to the permission of the resource owner. How to improve the authorization mechanism is a problem that needs to be considered.

### SUMMARY

Embodiments of the present disclosure disclose an authorization method and device, a communication device, and a storage medium.

A first aspect of embodiments of the present disclosure provides an authorization method which is performed by an application function (AF), including:
sending token request information to an authorization function,
wherein the token request information is configured to request an access token, and the access token is configured to authorize the AF to manage a first resource.

A second aspect of embodiments of the present disclosure provides an authorization method which is performed by an authorization function, including:
receiving token request information sent by an AF,
wherein the token request information is configured to request an access token, and the access token is configured to authorize the AF to manage the first resource.

A third aspect of embodiments of the present disclosure provides an authorization method which is performed by a NEF, including:
receiving resource management request information sent by an AF,
wherein the PIN management request information carries the access token, and is configured to request that the AF be authorized to manage the first resource.

A fourth aspect of embodiments of the present disclosure provides an authorization device, including:
a sending module, configured to send token request information to an authorization function,
wherein the token request information is configured to request an access token, and the access token is configured to authorize the AF to manage a first resource.

A fifth aspect of embodiments of the present disclosure provides an authorization device, including:
a receiving module, configured to receive token request information sent by an AF,
wherein the token request information is configured to request an access token, and the access token is configured to authorize the AF to manage a first resource.

A sixth aspect of embodiments of the present disclosure provides an authorization device of personal IoT network (PIN) authentication, including:
a receiving module, configured to receive PIN management request information sent by an AF,
wherein the PIN management request information carries the access token, and is configured to request to authorize the AF to manage the first resource.

A seventh aspect of embodiments of the present disclosure provides an authorization system including an AF, an authorization function, and a NEF, wherein the AF is configured to implement any method implemented by the AF as described in the present disclosure, the authorization function is configured to implement any method implemented by the authorization function as described in the present disclosure, and the NEF is configured to implement any method implemented by the NEF as described in the present disclosure.

An eighth aspect of embodiments of the present disclosure provides a communication device, including:
a processor; and
a memory storing executable instructions by the processor,
wherein the processor is configured to implement the method according to any embodiment of the present disclosure when running the executable instructions.

A ninth aspect of embodiments of the present disclosure provides a computer storage medium having computer-executable instructions stored thereon that, when being executed by a processor, implement the method according to any embodiment of the present disclosure.

### BRIEF DESCRIPTION OF THE DRAWINGS

FIG. 1 is a diagram of a structure of a wireless communication system according to an embodiment.

FIG. 2 is a flowchart of an authorization method according to an embodiment.

FIG. 3 is a flowchart of an authorization method according to an embodiment.

FIG. 4 is a flowchart of an authorization method according to an embodiment.

FIG. 5 is a flowchart of an authorization method according to an embodiment.

FIG. 6 is a flowchart of an authorization method according to an embodiment.

FIG. 7 is a flowchart of an authorization method according to an embodiment.

FIG. 8 is a flowchart of an authorization method according to an embodiment.

FIG. 9 is a flowchart of an authorization method according to an embodiment.

FIG. 10 is a flowchart of an authorization method according to an embodiment.

FIG. 11 is a flowchart of an authorization method according to an embodiment.

FIG. 12 is a flowchart of an authorization method according to an embodiment.

FIG. 13 is a diagram of an authorization device according to an embodiment.

FIG. 14 is a diagram of an authorization device according to an embodiment.

FIG. 15 is a diagram of an authorization device according to an embodiment.

FIG. 16 is a diagram of an authorization system according to an embodiment.

FIG. 17 is a diagram of a structure of a terminal according to an embodiment.

FIG. 18 is a block diagram of a base station according to an embodiment.

FIG. 19 is a diagram of a network architecture according to an embodiment.

### DETAILED DESCRIPTION

Embodiments will be described herein in detail, examples of which are represented in the accompanying drawings. When the following description relates to the accompanying drawings, the same numerals in the different figures indicate the same or similar elements unless otherwise indicated. The implementations described in the following embodiments do not represent all implementations consistent with the embodiments of the present disclosure. Rather, they are only examples of devices and methods consistent with some aspects of embodiments of the present disclosure as detailed in the appended claims.

The term used in the embodiments of the present disclosure is used solely for the purpose of describing particular embodiments and is not intended to limit the embodiments of the present disclosure. The singular forms such as “a”, “this” used in the embodiments of the present disclosure and the appended claims are also intended to encompass the plural forms, unless clearly indicated otherwise in the context. It is to be also understood that the term “and/or” as used herein refers to and encompasses any or all possible combinations of one or more of the associated listed items.

It is to be understood that while the terms first, second, third, etc. may be used in the embodiments of the present disclosure to describe various types of information, such information should not be limited to these terms. These terms are only used to distinguish the same type of information from one another. For example, without departing from the scope of the embodiments of the present disclosure, first information may also be referred to as second information, and similarly, the second information may be referred to as the first information as well. Depending on the context, the word “if” as used herein may be interpreted as “at the time of . . . ” or “when . . . ” or “in response to determining”.

For brevity and ease of understanding, the terms “greater than” or “less than” are used herein to describe a size relationship. However, a person skilled in the art may understand that the term “greater than” also encompasses the meaning of “greater than or equal to”, and the term “less than” also encompasses the meaning of “less than or equal to”.

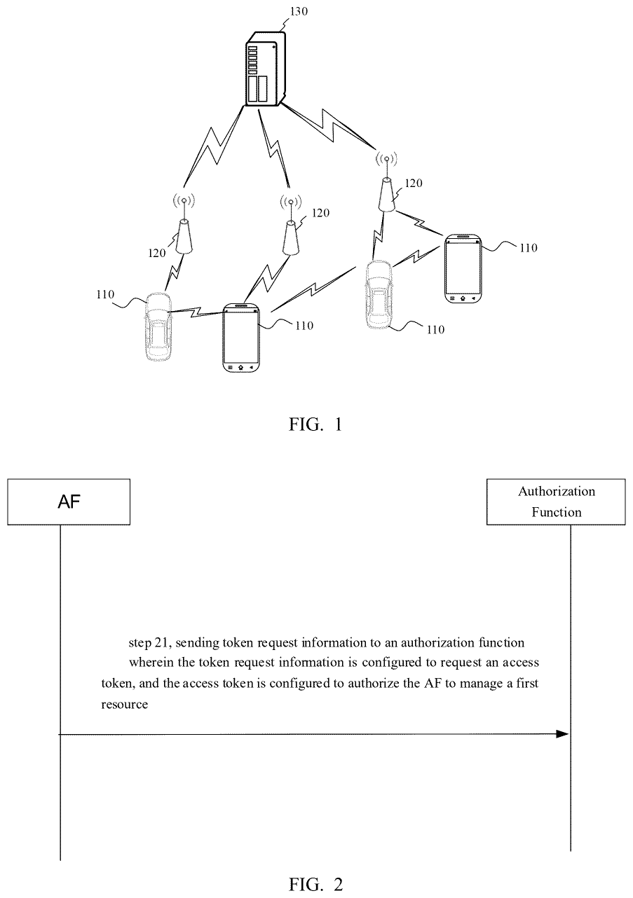

Referring to FIG. 1, a diagram of a structure of a wireless communication system according to an embodiment of the present disclosure is illustrated. As shown in FIG. 1, the wireless communication system is a communication system based on mobile communication technology, which may include at least one user equipment 110 and at least one access network node. For example, the access network node may be a base station 120. The user equipment 110 may be a terminal. Here, the terminal involved in the present disclosure may be, but is not limited to, a mobile phone, a wearable device, an in-vehicle terminal, a roadside unit (RSU), a smart home terminal, an industrial sensor device, and/or a medical device, etc. In some examples, the terminal may be a Redcap terminal or a new radio (NR) terminal of a predetermined release (e.g., an NR terminal in R17).

The user equipment 110 may be a device that provides voice and/or data connectivity to a user. The user equipment 110 may communicate with one or more core networks via a radio access network (RAN). The user equipment 110 may be an IoT user equipment, such as sensor device, mobile phone, and computer with a IoT user equipment, which may be, for example, fixed, portable, pocket-sized, handheld, computer-integrated, or vehicle-mounted device, for example, a station (STA), a subscriber unit, a subscriber station, a mobile station, a mobile, a remote station, an access point, a remote terminal, an access terminal, a user terminal, a user agent, a user device or a user equipment (UE). Alternatively, the user equipment 110 may be an unmanned aerial vehicle device. Alternatively, the user equipment 110 may be an in-vehicle device, e.g., it may be a trip computer with a wireless communication capability, or a wireless user equipment externally connected to a trip computer. Alternatively, the user equipment 110 may be a roadside device, e.g., it may be a street light, a signal light, or other roadside devices having a wireless communication capability.

The base station 120 may be a network-side device in the wireless communication system. The wireless communication system may be the 4^{th} generation mobile communication system, also known as a long term evolution (LTE) system, or may be a 5G system, also known as a new radio (NR) system or 5G NR system. Alternatively, the wireless communication system may be a next generation system of the 5G system or other future wireless communication systems. The access network in the 5G system may be called new generation-radio access network (NG-RAN).

The base station 120 may be an evolved base station (eNB) used in the 4G system. Alternatively, the base station 120 may be a base station (gNB) of a centralized distributed architecture used in the 5G system. When the base station 120 uses the centralized distributed architecture, it typically includes a central unit (CU) and at least two distributed units (DUs). The central unit is provided with a protocol stack of packet data convergence protocol (PDCP) layer, radio link control (RLC) layer, and media access control (MAC) layer, and the distributed unit is provided with a protocol stack of physical (PHY) layer. The specific implementation of the base station 120 is not limited in the embodiments of the present disclosure.

A wireless connection may be established between the base station 120 and the user equipment 110 via a wireless radio. In various implementations, the wireless radio is a wireless radio based on the 4^{th} generation mobile communication network technology (4G) standard; alternatively, the wireless radio is a wireless radio based on the 5th generation mobile communication network technology (5G) standard, for example, the wireless radio is the new radio; alternatively, the wireless radio may be a wireless radio based on a next generation mobile communication network technology standard based on the 5G.

In some examples, an E2E (End to End) connection may also be established between the user equipments 110, examples of which include vehicle to vehicle (V2V) communication, vehicle to infrastructure (V2I) communication, and vehicle to pedestrian (V2P) communication in a vehicle to everything (V2X) scenario or the like.

Here, the above user equipment may be considered as the terminal device in the following embodiments.

In some embodiments, the wireless communication system described above may further include a core network device 130.

The base station 120 is connected to the core network device 130. The core network device 130 may be a core network device in the wireless communication system. Herein, the core network device may correspond to a network function, for example, a communication node such as the access and mobility management function (AMF), the user plane function (UPF), and the session management function (SMF). The implementation form of the core network device 130 is not limited in the present disclosure.

In some embodiments of the present disclosure, the core network device 130 includes a network function that provides a location function. For example, in the 5G network, the location management function (LMF) is a network element, module or component that provides the location function. For another example, in the 4G network, the evolved serving mobile location center (ESMLC) is a network element, module or component that provides the location function. It is to be understood that in other networks, other function network elements may be used.

It is to be noted that in other embodiments, an access network node may also integrate a module or component that provides the location function, in which case the access network node serves as the network element, module or component that provides the location function.

In order to facilitate the understanding of a person skilled in the art, the embodiments of the present disclosure provide a plurality of implementations to clearly illustrate the technical solutions of the embodiments of the present disclosure. Of course, a person skilled in the art may understand that a plurality of embodiments provided in the embodiments of the present disclosure may be executed alone, or may be executed in combination with the methods of other embodiments among the embodiments of the present disclosure, or may be executed alone or in combination with some methods in other related technologies, which is not specifically limited in the embodiments of the present disclosure.

The following describes the application scenarios involved in the present disclosure.

In an embodiment, certain aspects of a PIN network may be configured by an AF through 5G NEF. For example, the resource of PIN includes QoS of the PIN, connection information related to the PIN or a URSP rule related to the PIN element, etc. From a security point of view, the access authorized to the AF should be restricted to a specific allowed PIN and needs to be subject to the permission of the resource owner (e.g., operator, terminal). Hence, there is a need to study how to enable the 5G core network to authorize the AF to request the configuration operation of a specific PIN based on permission of the resource owner.

It is to be understood that the network architecture and application scenario described in the embodiments of the present disclosure are provided to illustrate the technical solutions of the embodiments of the present disclosure more clearly and do not constitute a limitation on the technical solutions provided by the embodiments of the present disclosure. A person skilled in the art may understand that as the system architecture evolves and new service scenarios emerge, the technical solution provided by the embodiments of the present disclosure is equally applicable to similar technical problems.

As shown in FIG. 2, an embodiment provides an authorization method, which is performed by an application function (AF), and includes:
step 21, sending token request information to an authorization function,
wherein the token request information is configured to request an access token, and the access token is configured to authorize the AF to manage a first resource.

Here, the terminal involved in the present disclosure may be, but is not limited to, a mobile phone, a wearable device, an in-vehicle terminal, a roadside unit (RSU), a smart home terminal, an industrial sensor device, and/or a medical device, etc. In some examples, the terminal may be a Redcap terminal or a new radio (NR) terminal in a predetermined release (e.g., an NR terminal in R17). In the present disclosure, the authorization function includes one of:
a core function of common application programming interface (API) framework (CAPIF);
a network exposure function (NEF); or
a network repository function (NRF).

It is to be noted that the authorization function may be a network element with a function of authorization, for example, the function of authorization may be a function of issuing an access token. The network element may be an existing network element in the 5G architecture, such as CAPIF, NEF, and NRF, i.e., the authorization function may be integrated into the aforementioned existing network elements. Of course, the network element may also be a newly added network element in the 5G architecture which has the function of authorization, for example, a first network element, which is not limited herein. The network element involved in the present disclosure may be a base station or other evolved network elements in the 5th generation (5G) mobile communication network, which is not limited herein. The network element may be various physical network unit entities or logical network units.

In an embodiment of the present disclosure, the first resource may be a resource associated with a PIN network, such as hardware resources and software resources.

In an embodiment, the token request information is sent to the authorization function in response to determining that management of the first resource is to be performed. The token request information is configured to request the access token, and the access token is configured to authorize the AF to manage the first resource.

In an embodiment, the token request information is sent to the authorization function. The token request information is configured to request the access token, and the access token is configured to authorize the AF to manage the first resource. The token request information includes at least one of: an identity of the AF; an identity of a terminal; or an identity of the first resource. Here, the identity of the AF is used to uniquely identify one AF. After receiving the identity of the AF, the authorization function may determine that the token request information is sent by the AF indicated by the identity of AF. Here, the identity of the terminal is used to uniquely identify one terminal. After receiving the identity of the terminal, the authorization function determines whether to send the access token to the AF according to the permission of the terminal indicated by the identity of the terminal. Here, the identity of the first resource uniquely identifies the first resource. After receiving the identity of the first resource, the authorization function may determine that the resource to be managed by the AF is the resource indicated by the identity of the first resource. For example, the token request information includes the identity of the AF, the identity of the terminal and the identity of the first resource.

In an embodiment, the identity of the first resource includes at least one of an identity of a personal IoT network (PIN) or an identity of core network assistance information (5GC assistance information). The identity of the core network assistance information may include a data type of the core network assistance information and composition information (or details) of the core network assistance information.

Referring to Table 1, Table 1 shows the mapping relationship between a data source, the data type of the core network assistance information, and the details of the core network assistance information.

TABLE 1

| | Data Type of | |
|---|---|---|
| Data | 5GC Assistance | Detailed Data of 5GC Assistance |
| Source | Information | Information |
| UE-related | UE Status | Network authorization status of the UE |
| data | | Radio link quality (RSRP) of the UE |
| | UE location | TAI of the UE |
| 5GC- | UE related | UE related Packet loss rate prediction |
| related | Prediction | UE related Network congestion prediction |
| data | Information | Network load predictions at UE locations |
| | UE related | UE related S-NSSAI |
| | Slicing | |
| | Information | |
| Network- | UE related | User data congestion time prediction |
| assisted | Congestion | |
| data | UE related QoS | UE related QoS Sustainability Analytics |
| | | (NWDAF) |

In an embodiment, the token request information is sent to the authorization function. The token request information is configured to request the access token, and the access token is configured to authorize the AF to manage the first resource. The access token sent by the authorization function is received, in which the access token indicates the first resource. Thus, after receiving the access token, the AF may determine that the access token is an access token used to manage the first resource.

In an embodiment, the token request information is sent to the authorization function. The token request information is configured to request the access token, and the access token is configured to authorize the AF to manage the first resource. Based on a predetermined authorization architecture, the access token sent by the authorization function is received, in which the access token indicates the first resource. For example, the predetermined authorization architecture may be OAuth 2.0.

It is to be noted that the predefined authorization architecture such as OAuth 2.0 is an authorization framework that issues tokens based on a predefined authorization protocol and/or security transport protocol.

In an embodiment, the token request information is sent to the authorization function. The token request information is configured to request the access token, and the access token is configured to authorize the AF to manage the first resource. In response to that the authorization function authorizes the AF based on a predetermined service agreement, the access token sent by the authorization function is received based on a predetermined authorization architecture. The access token indicates the first resource, and the predetermined service agreement is a service agreement between the AF and an operator.

In an embodiment, the token request information is sent to the authorization function. The token request information is configured to request the access token, and the access token is configured to authorize the AF to manage the first resource. In response to that the authorization function authorizes the AF based on confirmation from a terminal, the access token sent by the authorization function is received based on a predetermined authorization architecture. The access token indicates the first resource.

In an embodiment, the token request information is sent to the authorization function. The token request information is configured to request the access token, and the access token is configured to authorize the AF to manage the first resource. In response to that the authorization function authorizes the AF based on a local policy, the access token sent by the authorization function is received based on a predetermined authorization architecture. The access token indicates the first resource.

In an embodiment, the token request information is sent to the authorization function. The token request information is configured to request the access token, and the access token is configured to authorize the AF to manage the first resource. The access token sent by the authorization function is received. The access token indicates at least one of: an identity of the first resource; an identity of the AF; an expected service name indicating a service authorized to process the first resource; or an expected service operation name indicating a service operation authorized to process the first resource. Here, the expected service may be a service that can be executed when authorizing the management of the first resource. The field corresponding to the expected service name may be “Nnef_ParameterProvision”, and the field corresponding to the expected service operation name may be at least one of “Nnef_ParameterProvision_Create”, “Nnef_ParameterProvision_Update”, “Nnef_ParameterProvision_Delete”, or ‘Nnef_ParameterProvision_Get’.

In an embodiment, the token request information is sent to the authorization function. The token request information is configured to request the access token, and the access token is configured to authorize the AF to manage the first resource. Identity authentication between the AF, the authorization function, a network exposure function (NEF) and/or a terminal is performed. Here, after the identity authentication between the AF, the authorization function, the network exposure function (NEF) and/or the terminal is performed, the AF, the authorization function, the network exposure function (NEF) and/or the terminal may communicate with each other.

In an embodiment, identity authentication between the AF, the authorization function, and the network exposure function (NEF) is performed; or identity authentication between the AF, the authorization function, and the terminal is performed; or identity authentication between the AF, the authorization function, the network exposure function (NEF), and the terminal is performed.

In an embodiment, the token request information is sent to the authorization function. The token request information is configured to request the access token, and the access token is configured to authorize the AF to manage the first resource. The access token sent by the authorization function is received. The access token indicates the first resource. Resource management request information is sent to a network exposure function (NEF). The resource management request information carries the access token, and is configured to request to authorize the AF to manage the first resource.

In an embodiment, the resource management request information further includes at least one of:
an identity of the AF;
an identity of a terminal;
an identity of the first resource;
a service name indicating a service requested to process the first resource;
a service operation name indicating a service operation requested to process the first resource; or
PIN-related information.

In an embodiment, the token request information is sent to the authorization function. The token request information is configured to request the access token, and the access token is configured to authorize the AF to manage the first resource. The access token sent by the authorization function is received. The access token indicates the first resource. The resource management request information is sent to the network exposure function (NEF). The resource management request information carries the access token, and is configured to request to authorize the AF to manage the first resource. Resource management response information sent by the NEF is received. The resource management response information indicates acceptance or rejection of the resource management request information. In response to the resource management response information indicating acceptance of the resource management request information, the AF is authorized to manage the first resource; or in response to the resource management response information indicating rejection of the resource management request information, the AF is not authorized to manage the first resource.

In embodiments of the present disclosure, the token request information is sent to the authorization function, the token request information is configured to request the access token, and the access token is configured to authorize the AF to manage the first resource. Thus, after the application function (AF) sends the token request information to the authorization function to request the access token, the authorization function can send the access token to the application function (AF). Upon receiving the access token, the application function (AF) can perform authorized operations to manage the first resource based on the access token. In comparison to a method not requesting the access token, it can improve the authorization mechanism for the application function (AF) to manage the first resource, making the management of the first resource more secure.

In some examples, a person skilled in the art may understand that the method provided by the embodiments of the present disclosure may be executed independently or in conjunction with some methods in the embodiments of the present disclosure or some methods in related art.

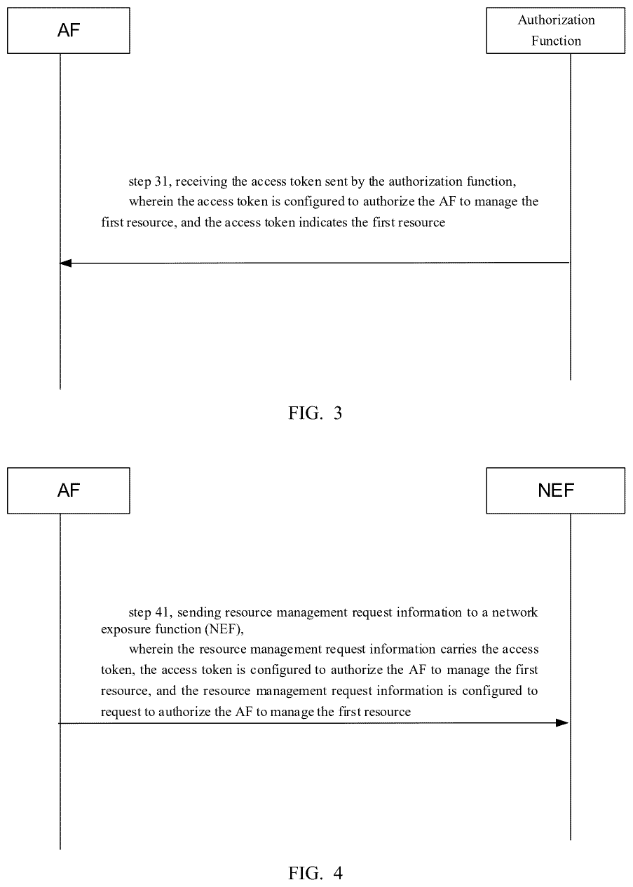

As shown in FIG. 3, an embodiment provides an authorization method, which is performed by the application function (AF), and includes:
step 31, receiving the access token sent by the authorization function,
wherein the access token is configured to authorize the AF to manage the first resource, and the access token indicates the first resource.

In an embodiment, the token request information is sent to the authorization function. The token request information is configured to request the access token, and the access token is configured to authorize the AF to manage the first resource. The access token sent by the authorization function is received, in which the access token indicates the first resource. Thus, after receiving the access token, the AF may determine that the access token is an access token used to manage the first resource.

In an embodiment, the token request information is sent to the authorization function. The token request information is configured to request the access token, and the access token is configured to authorize the AF to manage the first resource. Based on a predetermined authorization architecture, the access token sent by the authorization function is received, in which the access token indicates the first resource. For example, the predetermined authorization architecture may be OAuth 2.0.

In an embodiment, the token request information is sent to the authorization function. The token request information is configured to request the access token, and the access token is configured to authorize the AF to manage the first resource. The access token sent by the authorization function is received, in which the access token indicates the first resource. The access token indicates at least one of: an identity of the first resource; an identity of the AF; an expected service name indicating a service authorized to process the first resource; or an expected service operation name indicating a service operation authorized to process the first resource.

In an embodiment, the token request information is sent to the authorization function. The token request information is configured to request the access token, and the access token is configured to authorize the AF to manage the first resource. The access token sent by the authorization function is received. The access token indicates the first resource. Resource management request information is sent to a network exposure function (NEF). The resource management request information carries the access token, and is configured to request to authorize the AF to manage the first resource.

In an embodiment, the resource management request information further includes at least one of:
an identity of the AF;
an identity of a terminal;
an identity of the first resource;
a service name indicating a service requested to process the first resource;
a service operation name indicating a service operation requested to process the first resource; or
PIN-related information.

In an embodiment, the token request information is sent to the authorization function. The token request information is configured to request the access token, and the access token is configured to authorize the AF to manage the first resource. The access token sent by the authorization function is received. The access token indicates the first resource. The resource management request information is sent to the network exposure function (NEF). The resource management request information carries the access token, and is configured to request to authorize the AF to manage the first resource. Resource management response information sent by the NEF is received. The resource management response information indicates acceptance or rejection of the resource management request information. In response to the resource management response information indicating acceptance of the resource management request information, the AF is authorized to manage the first resource; or in response to the resource management response information indicating rejection of the resource management request information, the AF is not authorized to manage the first resource.

In some examples, a person skilled in the art may understand that the method provided by the embodiments of the present disclosure may be executed independently or in conjunction with some methods in the embodiments of the present disclosure or some methods in related art.

As shown in FIG. 4, an embodiment provides an authorization method, which is performed by the application function (AF), and includes:
step 41, sending resource management request information to a network exposure function (NEF),
wherein the resource management request information carries the access token, the access token is configured to authorize the AF to manage the first resource, and the resource management request information is configured to request to authorize the AF to manage the first resource.

In an embodiment, the resource management request information further includes at least one of:
an identity of the AF;
an identity of a terminal;
an identity of the first resource;
a service name indicating a service requested to process the first resource;
a service operation name indicating a service operation requested to process the first resource; or
PIN-related information.

In an embodiment, the access token sent by the authorization function is received. The access token is configured to authorize the AF to manage the first resource. The resource management request information is sent to the network exposure function (NEF). The resource management request information carries the access token, and is configured to request to authorize the AF to manage the first resource.

In an embodiment, the token request information is sent to the authorization function. The token request information is configured to request the access token, and the access token is configured to authorize the AF to manage the first resource. The access token sent by the authorization function is received. The resource management request information is sent to the network exposure function (NEF). The resource management request information carries the access token, and is configured to request to authorize the AF to manage the first resource.

In an embodiment, the token request information is sent to the authorization function. The token request information is configured to request the access token, and the access token is configured to authorize the AF to manage the first resource. The access token sent by the authorization function is received. The access token indicates the first resource. The resource management request information is sent to the network exposure function (NEF). The resource management request information carries the access token, and is configured to request to authorize the AF to manage the first resource. Resource management response information sent by the NEF is received. The resource management response information indicates acceptance or rejection of the resource management request information. In response to the resource management response information indicating acceptance of the resource management request information, the AF is authorized to manage the first resource; or in response to the resource management response information indicating rejection of the resource management request information, the AF is not authorized to manage the first resource.

In some examples, a person skilled in the art may understand that the method provided by the embodiments of the present disclosure may be executed independently or in conjunction with some methods in the embodiments of the present disclosure or some methods in related art.

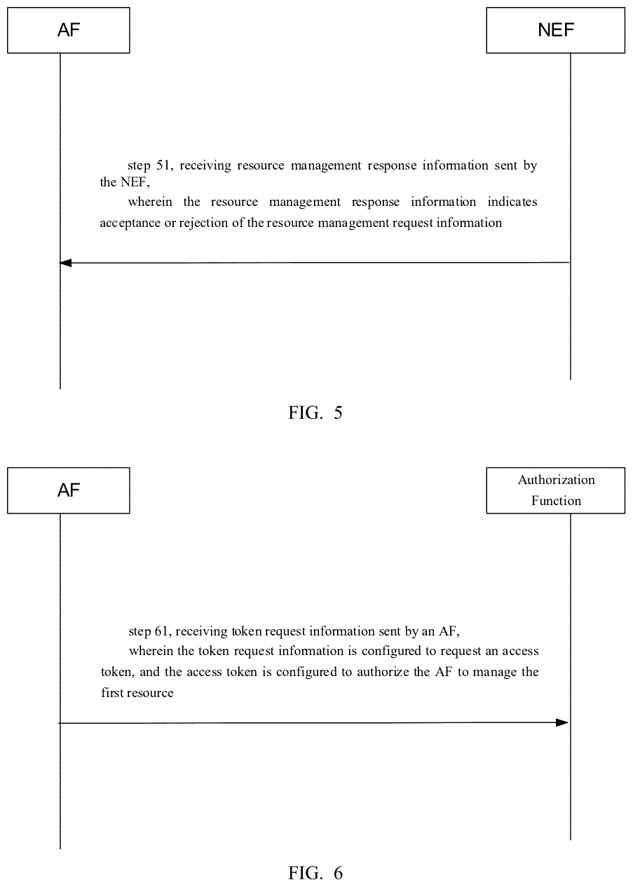

As shown in FIG. 5, an embodiment provides an authorization method, which is performed by the application function (AF), and includes:
step 51, receiving resource management response information sent by the NEF,
wherein the resource management response information indicates acceptance or rejection of the resource management request information.

In an embodiment, the token request information is sent to the authorization function. The token request information is configured to request the access token, and the access token is configured to authorize the AF to manage the first resource. The access token sent by the authorization function is received. The access token indicates the first resource. The resource management request information is sent to the network exposure function (NEF). The resource management request information carries the access token, and is configured to request to authorize the AF to manage the first resource. Resource management response information sent by the NEF is received. The resource management response information indicates acceptance or rejection of the resource management request information. In response to the resource management response information indicating acceptance of the resource management request information, the AF is authorized to manage the first resource; or in response to the resource management response information indicating rejection of the resource management request information, the AF is not authorized to manage the first resource.

In an embodiment, the access token indicates at least one of: an identity of the first resource; an identity of the AF; an expected service name; or an expected service operation name.

In an embodiment, the resource management request information further includes at least one of:
an identity of the AF;
an identity of a terminal;
an identity of the first resource;
a service name indicating a service requested to process the first resource;
a service operation name indicating a service operation requested to process the first resource; or
PIN-related information.

In some examples, a person skilled in the art may understand that the method provided by the embodiments of the present disclosure may be executed independently or in conjunction with some methods in the embodiments of the present disclosure or some methods in related art.

As shown in FIG. 6, an embodiment provides an authorization method, which is performed by an authorization function, and includes:
step 61, receiving token request information sent by an AF,
wherein the token request information is configured to request an access token, and the access token is configured to authorize the AF to manage the first resource.

Here, the terminal involved in the present disclosure may be, but is not limited to, a mobile phone, a wearable device, an in-vehicle terminal, a roadside unit (RSU), a smart home terminal, an industrial sensor device, and/or a medical device, etc. In some examples, the terminal may be a Redcap terminal or a new radio (NR) terminal in a predetermined release (e.g., an NR terminal in R17).

In the present disclosure, the authorization function includes one of:
a core function of common application programming interface (API) framework (CAPIF);
a network exposure function (NEF); or
a network repository function (NRF).

It is to be noted that the authorization function may be a network element with a function of authorization, for example, the function of authorization may be a function of issuing an access token. The network element may be an existing network element in the 5G architecture, such as CAPIF, NEF, and NRF, i.e., the authorization function may be integrated into the aforementioned existing network elements. Of course, the network element may also be a newly added and independent network element in the 5G architecture which has the function of authorization, for example, a first network element, which is not limited herein. The network element may be various physical network unit entities or logical network units. In an embodiment of the present disclosure, the first resource may be a resource associated with a PIN network, such as hardware resources and software resources.

In an embodiment, the token request information sent by the AF is received. The token request information is configured to request the access token, and the access token is configured to authorize the AF to manage the first resource. The token request information includes at least one of: an identity of the AF; an identity of a terminal; or an identity of the first resource. Here, the identity of the AF is used to uniquely identify one AF. After receiving the identity of the AF, the authorization function may determine that the token request information is sent by the AF indicated by the identity of AF. Here, the identity of the terminal is used to uniquely identify one terminal. After receiving the identity of the terminal, the authorization function determines whether to send the access token to the AF according to the permission of the terminal indicated by the identity of the terminal. Here, the identity of the first resource uniquely identifies the first resource. After receiving the identity of the first resource, the authorization function may determine that the resource to be managed by the AF is the resource indicated by the identity of the first resource. For example, the token request information includes the identity of the AF, the identity of the terminal and the identity of the first resource.

In an embodiment, the identity of the first resource includes at least one of an identity of a personal IoT network (PIN) or an identity of core network assistance information. The identity of the core network assistance information may include a data type of the core network assistance information and composition information (or details) of the core network assistance information.

Referring to Table 1, Table 1 shows the mapping relationship between a data source, the data type of the core network assistance information, and the details of the core network assistance information.

In an embodiment, the token request information sent by the AF is received. The token request information is configured to request the access token, and the access token is configured to authorize the AF to manage the first resource. The access token is sent to the AF, in which the access token indicates the first resource. Thus, after receiving the access token, the AF may determine that the access token is an access token used to manage the first resource.

In an embodiment, the token request information sent by the AF is received. The token request information is configured to request the access token, and the access token is configured to authorize the AF to manage the first resource. The access token is sent to the AF based on a predefined authorization framework, in which the access token indicates the first resource. For example, the predetermined authorization architecture may be OAuth 2.0.

In an embodiment, the token request information sent by the AF is received. The token request information is configured to request the access token, and the access token is configured to authorize the AF to manage the first resource. In response to the determination of authorizing the AF based on a predetermined service agreement, the access token is sent to the AF. The access token indicates the first resource, and the predetermined service agreement is a service agreement between the AF and an operator.

In an embodiment, the token request information sent by the AF is received. The token request information is configured to request the access token, and the access token is configured to authorize the AF to manage the first resource. In response to the determination of authorizing the AF based on confirmation from a terminal, the access token is sent to the AF. The access token indicates the first resource. Here, the confirmation from the terminal indicates that the authorization to the AF is agreed.

In an embodiment, the token request information sent by the AF is received. The token request information is configured to request the access token, and the access token is configured to authorize the AF to manage the first resource. In response to that the authorization function determines to authorize the AF based on a local policy, the access token is sent to the AF. The access token indicates the first resource.

In an embodiment, the token request information sent by the AF is received. The token request information is configured to request the access token, and the access token is configured to authorize the AF to manage the first resource. The access token is sent to the AF. The access token indicates at least one of: an identity of the first resource; an identity of the AF; an expected service name indicating a service authorized to process the first resource; or an expected service operation name indicating a service operation authorized to process the first resource. Here, the expected service may be a service that can be executed when authorizing the management of the first resource. The field corresponding to the expected service name may be “Nnef_ParameterProvision”, and the field corresponding to the expected service operation name may be at least one of “Nnef_ParameterProvision_Create”, “Nnef_ParameterProvision_Update”, “Nnef_ParameterProvision_Delete”, or ‘Nnef_ParameterProvision_Get’.

In an embodiment, the token request information sent by the AF is received. The token request information is configured to request the access token, and the access token is configured to authorize the AF to manage the first resource. Identity authentication between the AF, the authorization function, a network exposure function (NEF) and/or a terminal is performed. Here, after the identity authentication between the AF, the authorization function, the network exposure function (NEF) and/or the terminal is performed, the AF, the authorization function, the network exposure function (NEF) and/or the terminal may communicate with each other.

In an embodiment, identity authentication between the AF, the authorization function, and the network exposure function (NEF) is performed; or identity authentication between the AF, the authorization function, and the terminal is performed; or identity authentication between the AF, the authorization function, the network exposure function (NEF), and the terminal is performed.

In an embodiment, the authorization function receives the token request information sent by the AF. The token request information is configured to request the access token, and the access token is configured to authorize the AF to manage the first resource. The authorization function sends the access token sent to the AF. The access token indicates the first resource. The AF sends resource management request information to a network exposure function (NEF). The resource management request information carries the access token, and is configured to request to authorize the AF to manage the first resource. The AF receives resource management response information sent by the NEF. The resource management response information indicates acceptance or rejection of the resource management request information. In response to the resource management response information indicating acceptance of the resource management request information, the AF is authorized to manage the first resource; or in response to the resource management response information indicating rejection of the resource management request information, the AF is not authorized to manage the first resource.

In some examples, a person skilled in the art may understand that the method provided by the embodiments of the present disclosure may be executed independently or in conjunction with some methods in the embodiments of the present disclosure or some methods in related art.

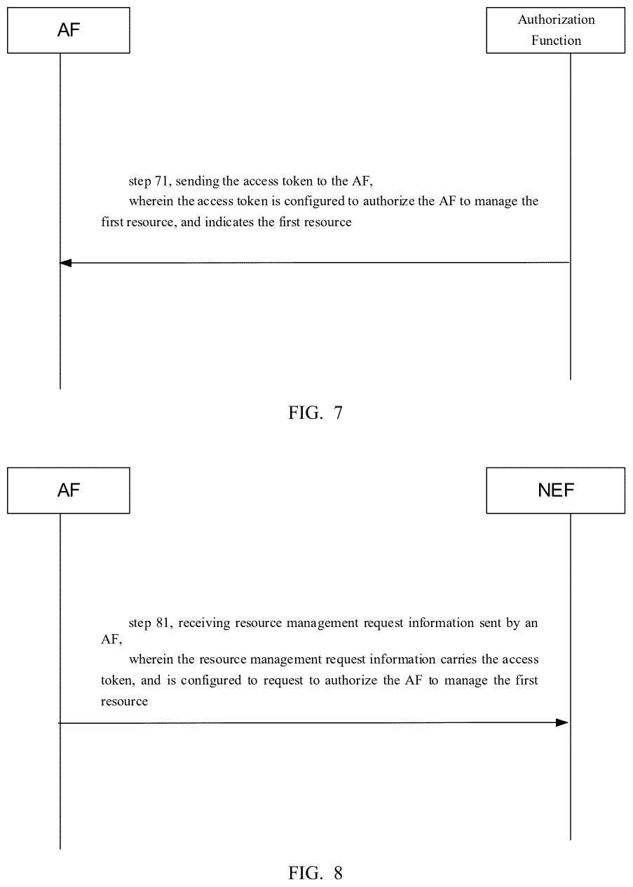

As shown in FIG. 7, an embodiment provides an authorization method, which is performed by the authorization function, and includes:
step 71, sending the access token to the AF,
wherein the access token is configured to authorize the AF to manage the first resource, and the access token indicates the first resource.

In an embodiment, the token request information sent by the AF is received. The token request information is configured to request the access token, and the access token is configured to authorize the AF to manage the first resource. The access token is sent to the AF. The access token indicates the first resource. Thus, after receiving the access token, the AF may determine that the access token is an access token used to manage the first resource.

In an embodiment, the token request information sent by the AF is received. The token request information is configured to request the access token, and the access token is configured to authorize the AF to manage the first resource. The access token is sent to the AF based on a predefined authorization framework, in which the access token indicates the first resource. For example, the predetermined authorization architecture may be OAuth 2.0.

In an embodiment, the token request information sent by the AF is received. The token request information is configured to request the access token, and the access token is configured to authorize the AF to manage the first resource. In response to the determination of authorizing the AF based on a predetermined service agreement, the access token is sent to the AF. The access token indicates the first resource, and the predetermined service agreement is a service agreement between the AF and an operator.

In an embodiment, the token request information sent by the AF is received. The token request information is configured to request the access token, and the access token is configured to authorize the AF to manage the first resource. In response to the determination of authorizing the AF based on confirmation from a terminal, the access token is sent to the AF. The access token indicates the first resource. Here, the confirmation from the terminal indicates that the authorization to the AF is agreed.

In an embodiment, the token request information sent by the AF is received. The token request information is configured to request the access token, and the access token is configured to authorize the AF to manage the first resource. In response to that the authorization function determines to authorize the AF based on a local policy, the access token is sent to the AF. The access token indicates the first resource.

In an embodiment, the token request information sent by the AF is received. The token request information is configured to request the access token, and the access token is configured to authorize the AF to manage the first resource. The access token is sent to the AF. The access token indicates at least one of: an identity of the first resource; an identity of the AF; an expected service name indicating a service authorized to process the first resource; or an expected service operation name indicating a service operation authorized to process the first resource. Here, the expected service may be a service that can be executed when authorizing the management of the first resource.

In an embodiment, the authorization function receives the token request information sent by the AF. The token request information is configured to request the access token, and the access token is configured to authorize the AF to manage the first resource. The authorization function sends the access token sent to the AF. The access token indicates the first resource. The AF sends resource management request information to a network exposure function (NEF). The resource management request information carries the access token, and is configured to request to authorize the AF to manage the first resource. The AF receives resource management response information sent by the NEF. The resource management response information indicates acceptance or rejection of the resource management request information. In response to the resource management response information indicating acceptance of the resource management request information, the AF is authorized to manage the first resource; or in response to the resource management response information indicating rejection of the resource management request information, the AF is not authorized to manage the first resource.

In some examples, a person skilled in the art may understand that the method provided by the embodiments of the present disclosure may be executed independently or in conjunction with some methods in the embodiments of the present disclosure or some methods in related art.

As shown in FIG. 8, an embodiment provides an authorization method, which is performed by a NEF, and includes:
step 81, receiving resource management request information sent by an AF,
wherein the resource management request information carries the access token, and is configured to request to authorize the AF to manage the first resource.

Here, the terminal involved in the present disclosure may be, but is not limited to, a mobile phone, a wearable device, an in-vehicle terminal, a roadside unit (RSU), a smart home terminal, an industrial sensor device, and/or a medical device, etc. In some examples, the terminal may be a Redcap terminal or a new radio (NR) terminal in a predetermined release (e.g., an NR terminal in R17).

In the present disclosure, the authorization function includes one of:
a core function of common application programming interface (API) framework (CAPIF);
a network exposure function (NEF); or
a network repository function (NRF).

It is to be noted that the authorization function may be a network element with a function of authorization, for example, the function of authorization may be a function of issuing an access token. The network element may be an existing network element in the 5G architecture, such as CAPIF, NEF, and NRF, i.e., the authorization function may be integrated into the aforementioned existing network elements. Of course, the network element may also be a newly added network element in the 5G architecture which has the function of authorization, for example, a first network element, which is not limited herein. The network element involved in the present disclosure may be a base station or other evolved network elements in the 5^{th} generation (5G) mobile communication network, which is not limited herein. The network element may be various physical network unit entities or logical network units. In an embodiment of the present disclosure, the first resource may be a resource associated with a PIN network, such as hardware resources and software resources.

In an embodiment, the resource management request information sent by the AF is received. The resource management request information carries the access token, and is configured to request to authorize the AF to manage the first resource. The access token indicates at least one of: an identity of the first resource; an identity of a terminal; an identity of the AF; an expected service name indicating a service authorized to process the first resource; or an expected service operation name indicating a service operation authorized to process the first resource. The resource management request information further includes at least one of: an identity of the AF; an identity of a terminal; an identity of the first resource; a service name indicating a service requested to process the first resource; a service operation name indicating a service operation requested to process the first resource; or PIN-related information.

In an embodiment, the identity of the first resource includes at least one of an identity of a personal IoT network (PIN) or an identity of core network assistance information. The identity of the core network assistance information may include a data type of the core network assistance information and composition information (or details) of the core network assistance information.

Referring to Table 1 again, Table 1 shows the mapping relationship between a data source, the data type of the core network assistance information, and the details of the core network assistance information.

In an embodiment, the resource management request information sent by the AF is received. The resource management request information carries the access token, and is configured to request to authorize the AF to manage the first resource. Integrity verification of the access token is performed in response to receiving the resource management request information.

In an embodiment, the resource management request information sent by the AF is received. The resource management request information carries the access token, and is configured to request to authorize the AF to manage the first resource. Integrity verification of the access token is performed in response to receiving the resource management request information. The resource management request information is rejected in response to the integrity verification of the access token failing. In response to the integrity verification of the access token succeeding, the resource management request information is verified based on the access token.

In an embodiment, the resource management request information sent by the AF is received. The resource management request information carries the access token, and is configured to request to authorize the AF to manage the first resource. Integrity verification of the access token is performed in response to receiving the resource management request information. In response to the integrity verification of the access token succeeding, the resource management request information is verified based on the access token. It determines whether an identity of the first resource in the access token matches an identity of the first resource contained in the PIN management request information; and/or it determines whether the expected service identity in the access token matches a service identity contained in the PIN management request information; and/or it determines whether the expected service operation identity in the access token matches a service operation identity contained in the PIN management request information. If any of the above three does not match, the verification of the resource management request information fails.

In an embodiment, the resource management request information sent by the AF is received. The resource management request information carries the access token, and is configured to request to authorize the AF to manage the first resource. Integrity verification of the access token is performed in response to receiving the resource management request information. In response to the integrity verification of the access token succeeding, the resource management request information is verified based on the access token. The resource management request information is rejected in response to the verifying of the resource management request information failing, or the resource management request information is accepted in response to the verifying of the resource management request information succeeding.

In an embodiment, the resource management request information sent by the AF is received. The PIN management request information carries the access token, and is configured to request to authorize the AF to manage the first resource. In response to accepting the resource management request information, the PIN-related information and an identity of the first resource contained in the resource management request information is sent to a unified data repository (UDR) function.

In an embodiment, the resource management request information sent by the AF is received. The resource management request information carries the access token, and is configured to request to authorize the AF to manage the first resource. In response to accepting the resource management request information, resource management response information is sent to the AF, in which the resource management response information indicates acceptance of the resource management request information. Alternatively, in response to rejecting the resource management request information, resource management response information is sent to the AF, in which the resource management response information indicates rejection of the resource management request information.

In some examples, a person skilled in the art may understand that the method provided by the embodiments of the present disclosure may be executed independently or in conjunction with some methods in the embodiments of the present disclosure or some methods in related art.

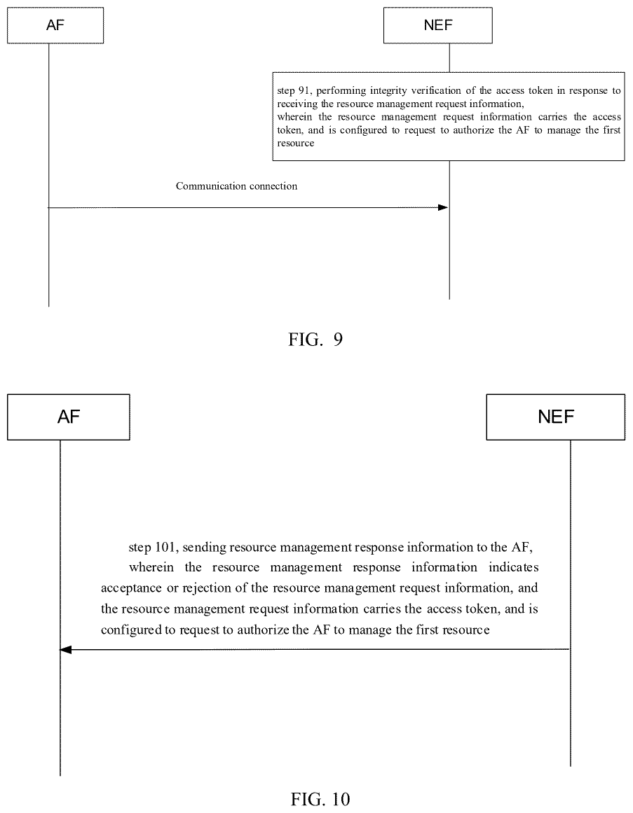

As shown in FIG. 9, an embodiment provides an authorization method, which is performed by the NEF, and includes:
step 91, performing integrity verification of the access token in response to receiving the resource management request information,
wherein the resource management request information carries the access token, and is configured to request to authorize the AF to manage the first resource.

In an embodiment, the resource management request information sent by the AF is received. The resource management request information carries the access token, and is configured to request to authorize the AF to manage the first resource. Integrity verification of the access token is performed in response to receiving the resource management request information. In response to the integrity verification of the access token succeeding, the resource management request information is verified based on the access token. The resource management request information is rejected in response to the verifying of the resource management request information failing, or the resource management request information is accepted in response to the verifying of the resource management request information succeeding.

In an embodiment, the resource management request information sent by the AF is received. The resource management request information carries the access token, and is configured to request to authorize the AF to manage the first resource. Integrity verification of the access token is performed in response to receiving the resource management request information. In response to the integrity verification of the access token succeeding, the resource management request information is verified based on the access token. It determines whether an identity of the first resource in the access token matches an identity of the first resource contained in the PIN management request information; and/or it determines whether the expected service identity in the access token matches a service identity contained in the PIN management request information; and/or it determines whether the expected service operation identity in the access token matches a service operation identity contained in the PIN management request information. If any of the above three does not match, the verification of the resource management request information fails.

In some examples, a person skilled in the art may understand that the method provided by the embodiments of the present disclosure may be executed independently or in conjunction with some methods in the embodiments of the present disclosure or some methods in related art.

As shown in FIG. 10, an embodiment provides an authorization method, which is performed by the NEF, and includes:
step 101, sending resource management response information to the AF,
wherein the resource management response information indicates acceptance or rejection of the resource management request information, and the resource management request information carries the access token, and is configured to request to authorize the AF to manage the first resource.

In an embodiment, the resource management request information sent by the AF is received. The resource management request information carries the access token, and is configured to request to authorize the AF to manage the first resource. In response to accepting the resource management request information, resource management response information is sent to the AF, in which the resource management response information indicates acceptance of the resource management request information. Alternatively, in response to rejecting the resource management request information, resource management response information is sent to the AF, in which the resource management response information indicates rejection of the resource management request information.

In an embodiment, the resource management request information sent by the AF is received. The resource management request information carries the access token, and is configured to request to authorize the AF to manage the first resource. Integrity verification of the access token is performed in response to receiving the resource management request information. In response to the integrity verification of the access token succeeding, the resource management request information is verified based on the access token. The resource management request information is rejected in response to the verifying of the resource management request information failing, or the resource management request information is accepted in response to the verifying of the resource management request information succeeding.

In an embodiment, the resource management request information sent by the AF is received. The resource management request information carries the access token, and is configured to request to authorize the AF to manage the first resource. Integrity verification of the access token is performed in response to receiving the resource management request information. In response to the integrity verification of the access token succeeding, the resource management request information is verified based on the access token. It determines whether an identity of the first resource in the access token matches an identity of the first resource contained in the PIN management request information; and/or it determines whether the expected service identity in the access token matches a service identity contained in the PIN management request information; and/or it determines whether the expected service operation identity in the access token matches a service operation identity contained in the PIN management request information. If any of the above three does not match, the verification of the resource management request information fails.

In some examples, a person skilled in the art may understand that the method provided by the embodiments of the present disclosure may be executed independently or in conjunction with some methods in the embodiments of the present disclosure or some methods in related art.

To better understand the embodiments of the present disclosure, the technical solution of the present disclosure is further illustrated below through an embodiment:

### Example 1

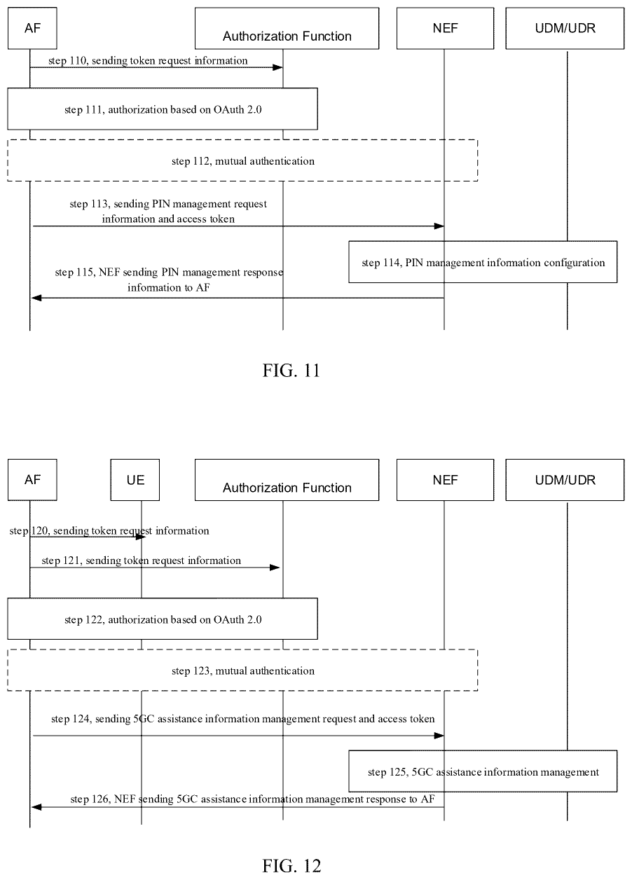

As shown in FIG. 11, an embodiment provides an authorization method including:
step 110, sending token request information, in which to obtain authorization to manage a specific PIN (corresponding to the first resource in the present disclosure), AF sends the token request information to an authorization function, the token request information includes an identity of the AF (e.g., AF ID and fully qualified domain name (FQDN)) and an identify of the PIN;
step 111, authorization based on OAuth 2.0, in which the AF obtains an access token from the authorization function via OAuth 2.0, the authorization is based on a service agreement between the AF and a 3GPP operator, the service agreement may specify the identity of the PIN that can be managed by the AF, the access token includes the identity of the PIN, and the access token may also include the identity of the AF, a service name (e.g., Nnef_ParameterProvision), and a service operation name (e.g., Nnef_ParameterProvision_Create, Nnef_ParameterProvision_Update, Nnef_ParameterProvision_Delete, and Nnef_ParameterProvision_Get) for use by the AF;
step 112, mutual authentication, in which the mutual authentication is performed between the AF, a terminal, the authorization function, and NEF;
step 113, sending PIN management request information (corresponding to the resource management request information in the present disclosure) and the access token, in which to manage the specific PIN (the first resource), the AF sends the PIN management request information and the access token to the NEF, the PIN management request information may include the identity of the AF, the identity of the PIN, the service name, the service operation name, and PIN-related information;
step 114, PIN management information configuration, in which the NEF authorizes the PIN management request information based on the access token; specifically, the NEF first checks the integrity of the access token; if the token has been tampered, the NEF rejects the PIN management request information; otherwise, the NEF checks the PIN management request information based on the access token; in particular, the NEF verifies whether the PIN identity included in the PIN management request information matches the PIN identity in the access token; if the AF is authorized to perform the PIN management request information, the NEF provides related PIN information in the PIN management request information along with the identity information of the PIN to the UDR or unified data management (UDM) function; otherwise, the NEF needs to reject the PIN management request information; and
step 115, the NEF sending the PIN management response information (corresponding to the resource management response information in the present disclosure) to the AF.

### Example 2

As shown in FIG. 12, an embodiment provides an authorization method including:
step 120, an AF sending token request information to a terminal, or step 121, the AF sending the token request information to an authorization function, in which the token request information includes an identity of 5GC assistance information and/or an identity of a terminal;
step 122, authorization based on OAuth 2.0, in which the AF, terminal, and authorization function complete authorization based on OAuth 2.0, and the authorization function sends an access token to the AF, and the access token includes the identity of 5GC assistance information and/or the identity of the terminal;
step 123, mutual authentication, in which the mutual authentication is performed between the AF, terminal, authorization function, and NEF;
step 124, sending core network assistance information management request information and access token, in which the core network assistance information management request may include identities related to services or service operations such as configuration, exposure, obtaining, deleting, updating, creating, etc.;
step 125, 5GC assistance information management, in which the NEF performs authorization based on the access token; if the NEF authorizes the 5GC assistance information management request of the AF, the NEF executes the 5GC assistance information management request, for example, the NEF may request the 5GC to expose 5GC assistance information related to the identity of the terminal based on the request of the AF; and
step 126, the NEF sending response information (corresponding to the resource management response information in the present disclosure) to the AF.

In an embodiment, based on Example 2, corresponding to steps 120 to 123, an embodiment provides an authorization method including:
step 130, an AF sending token request information to a terminal, or step 131, the AF sending the token request information to an authorization function, wherein the token request information includes an identity of resource and/or an identity of the terminal;
step 132, authorization based on OAuth 2.0, in which the AF, terminal, and authorization function complete authorization based on OAuth 2.0, the authorization function sends an access token to the AF, and the access token includes the identity of the resource and/or identity of the terminal; and
step 133, mutual authentication, in which the mutual authentication is performed between the AF, terminal, authorization function, and NEF.

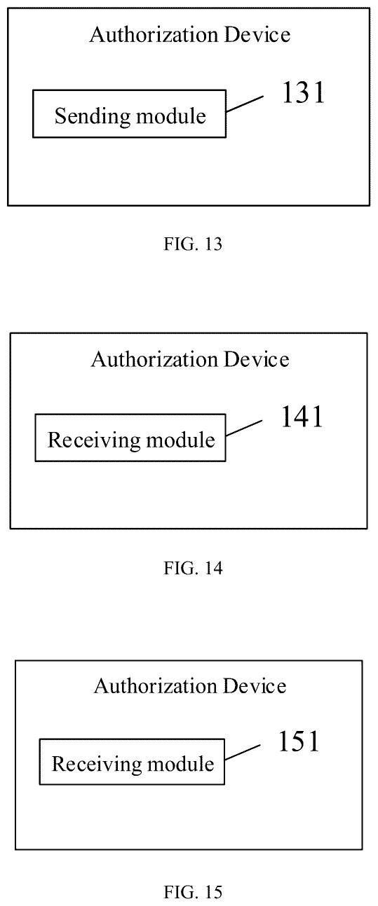

As shown in FIG. 13, an embodiment of the present disclosure provides an authorization device, including:
a sending module 131, configured to send token request information to an authorization function,
wherein the token request information is configured to request an access token, and the access token is configured to authorize the AF to manage a first resource.

As shown in FIG. 14, an embodiment of the present disclosure provides an authorization device, including:
a receiving module 141, configured to receive token request information sent by an AF,
wherein the token request information is configured to request an access token, and the access token is configured to authorize the AF to manage a first resource.

As shown in FIG. 15, an embodiment of the present disclosure provides an authorization device, including:
a receiving module 151, configured to receive PIN management request information sent by an AF,
wherein the PIN management request information carries the access token, and is configured to request to authorize the AF to manage the first resource.

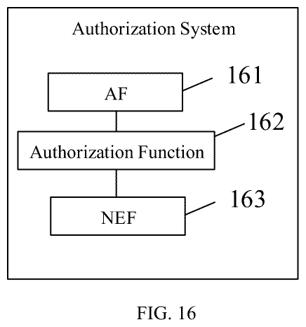

As shown in FIG. 16, the present disclosure provides an authorization system including an AF 161, an authorization function 162, and a NEF 163, wherein the AF is configured to implement any method implemented by the AF as described in the present disclosure, the authorization function is configured to implement any method implemented by the authorization function as described in the present disclosure, and the NEF is configured to implement any method implemented by the NEF as described in the present disclosure.

An embodiment of the present disclosure provides a communication device, including:
a processor; and
a memory storing executable instructions by the processor,
wherein the processor is configured to implement the method according to any embodiment of the present disclosure when running the executable instructions.

The processor may include various types of storage media, which are non-transitory computer storage media capable of retaining the information stored thereon even after the communication device is powered off.

The processor may be connected to the memory via a bus or the like to read the executable program stored in the memory.

An embodiment of the present disclosure provides a computer storage medium having computer-executable instructions stored thereon that, when being executed by a processor, implement the method according to any embodiment of the present disclosure.

Regarding the devices in the above embodiments, the specific manner in which each module performs operations has been described in detail in the embodiments of the method, which will not be described in detail here.

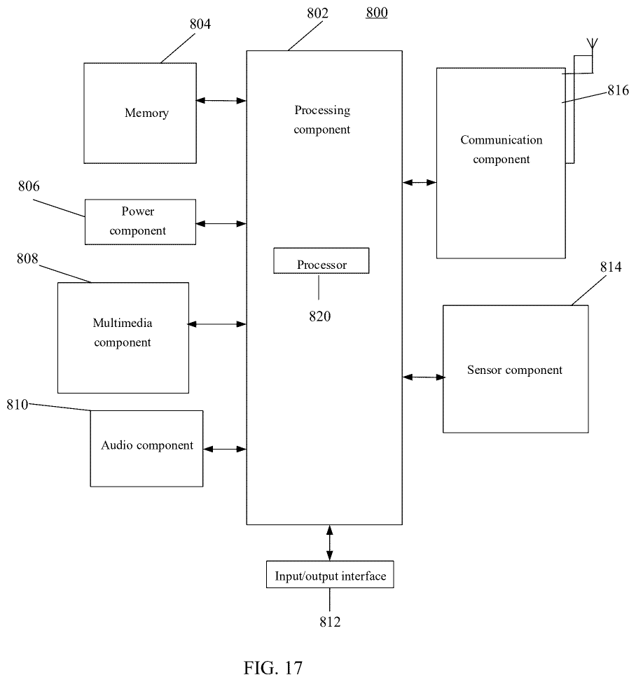

As shown in FIG. 17, an embodiment of the present disclosure provides a structure of a terminal.

Referring to FIG. 17, an embodiment of the present disclosure provides a terminal 800. Specifically, the terminal 800 may be a mobile phone, a computer, a digital broadcasting terminal, a messaging device, a game console, a tablet device, a medical device, a fitness device, a personal digital assistant, or the like.

Referring to FIG. 17, the terminal 800 may include one or more of a processing component 802, a memory 804, a power component 806, a multimedia component 808, an audio component 810, an input/output (I/O) interface 812, a sensor component 814, and a communication component 816.

The processing component 802 generally controls the overall operations of the terminal 800, such as operations associated with display, telephone calls, data communications, camera operations, and recording operations. The processing component 802 may include one or more processors 820 to execute instructions to complete all or part of the steps of the foregoing method. In addition, the processing component 802 may include one or more modules to facilitate interaction between the processing component 802 and other components. For example, the processing component 802 may include a multimedia module to facilitate the interaction between the multimedia component 808 and the processing component 802.

The memory 804 is configured to store various types of data to support the operation of the terminal 800. Examples of these data include instructions for any application or method operating on the terminal 800, contact data, phone book data, messages, pictures, videos and the like. The memory 804 may be implemented by any type of volatile or non-volatile storage device or a combination thereof, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 806 provides power to various components of the terminal 800. The power component 806 may include a power management system, one or more power supplies, and other components associated with generating, managing, and distributing power for the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor may not only sense the boundary of the touch or slide action, but also detect the duration and pressure related to the touch or slide operation. In some examples, the multimedia component 808 includes a front camera and/or a rear camera. When the terminal 800 is in an operation mode, such as a shooting mode or a video mode, the front camera and/or the rear camera can receive external multimedia data. Each of the front camera and rear camera may be a fixed optical lens system or have focal length and optical zoom capabilities.

The audio component 810 is configured to output and/or be input audio signals. For example, the audio component 810 includes a microphone (MIC), and when the terminal 800 is in an operation mode, such as a call mode, a recording mode, and a voice recognition mode, the microphone is configured to receive an external audio signal. The received audio signal can be further stored in the memory 804 or sent via the communication component 816. In some embodiments, the audio component 810 further includes a speaker for outputting audio signals.

The I/O interface 812 provides an interface between the processing component 802 and a peripheral interface module. The above-mentioned peripheral interface module may be a keyboard, a click wheel, a button, and the like. These buttons may include but are not limited to home button, volume button, start button, and lock button.

The sensor component 814 includes one or more sensors for providing the terminal 800 with various aspects of state evaluation. For example, the sensor component 814 can detect the on/off status of the terminal 800 and the relative positioning of components. For example, the component is a display and keypad of the terminal 800. The sensor component 814 can also detect the position change of the terminal 800 or a component of the terminal 800, the presence or absence of contact between the user and the terminal 800, the orientation or acceleration/deceleration of the terminal 800, and the temperature change of the terminal 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 can access a wireless network based on a communication standard, such as WiFi, 2G, 3G, 4G or 5G, or a combination thereof. In an embodiment, the communication component 816 receives a broadcast signal or broadcast related information from an external broadcast management system via a broadcast channel. In an embodiment, the communication component 816 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment, the terminal 800 may be implemented by one or more of application specific integrated circuit (ASIC), digital signal processor (DSP), digital signal processing device (DSPD), programmable logic devices (PLD), field programmable gate array (FPGA), controller, microcontroller, microprocessor, or other electronic components, to perform the above-mentioned methods.

An embodiment also provides a non-transitory computer-readable storage medium including instructions, such as the memory 804 including instructions, and the instructions may be executed by the processor 820 of the terminal 800 to complete the foregoing method. For example, the non-transitory computer-readable storage medium may be ROM, random access memory (RAM), CD-ROM, magnetic tape, floppy disk, optical data storage device and the like.

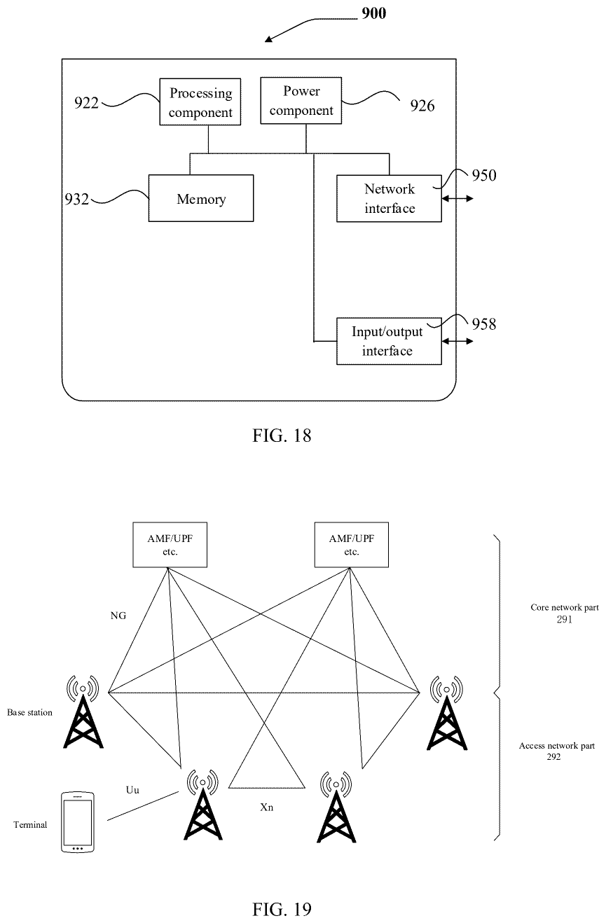

As shown in FIG. 18, an embodiment of the present disclosure illustrates a structure of a base station. For example, the base station 900 may be provided as a network side device. Referring to FIG. 18, the base station 900 includes a processing component 922 which further includes one or more processors, and a memory resource which is represented by a memory 932 and is configured for storing instructions such as application programs executable by the processing component 922. The application program stored in the memory 932 may include one or more modules each corresponding to a set of instructions. Furthermore, the processing component 922 is configured to execute instructions to perform the method applied to the base station among the above methods.

The base station 900 may also include a power component 926 configured to perform power management of the base station 900, a wired or wireless network interface 950 configured to connect the base station 900 to a network, and an input/output (I/O) interface 959. The base station 900 may operate based on an operating system stored in memory 932, such as Windows Server™, Mac OS X™, Unix™, Linux™, Free BSD™ or the like.

As shown in FIG. 19, an embodiment of the present disclosure illustrates a network architecture of a 5G system, including a core network part 291 and an access network part 292. The core network part includes a core network device, which mainly includes communication nodes such as access and mobility management function (AMF), user plane function (UPF), network exposure function (NEF), user data repository (UDR), and session management function (SMF). The access network part includes a base station. The AMF is primarily responsible for functions such as registration management, connection management, access management, mobility management, and various functions related to security, access management, and authorization. The UPF is primarily responsible for functions such as data plane anchors, PDU session points for connecting to data networks, message routing and forwarding, traffic usage reporting, and lawful interception. The NEF is primarily responsible for providing a secure path to expose the service and capability of the 3GPP network function to the AF, and providing a secure path for the AF to provide related functions of information to the 3GPP network. The UDR is primarily responsible for storing important process data during wireless communication. The SMF is primarily responsible for session management, billing and QoS policy control, lawful interception, billing data collection, and downlink data notification, among other functions.

A person skilled in the art may easily conceive of other embodiments of the present disclosure upon consideration of the specification and practice of the invention disclosed herein. The present disclosure is intended to cover any variations, uses, or adaptations of the present disclosure that follow the general principles of the present disclosure and include the common general knowledge or conventional technical means in the technical field not disclosed by the present disclosure. The specification and embodiments are to be regarded as exemplary only, and the true scope and spirit of the present disclosure are indicated by the following claims.

It is to be understood that the present disclosure is not limited to the precise structures described above and illustrated in the accompanying drawings, and that various modifications and changes may be made without departing from the scope thereof. The scope of the present disclosure is limited only by the appended claims.

1. An authorization method which is performed by an application function (AF), comprising:
sending token request information to an authorization function,
wherein the token request information is configured to request an access token, and the access token is configured to authorize the AF to manage a first resource.

2. The authorization method according to claim 1, wherein the token request information comprises at least one of:
an identity of the AF;
an identity of a terminal; or
an identity of the first resource,
wherein the identity of the first resource comprises at least one of:
an identity of a personal IoT network (PIN); or
an identity of core network assistance information.

3. (canceled)

4. The authorization method according to claim 1, further comprising:
receiving the access token sent by the authorization function,
wherein the access token indicates the first resource.

5. (canceled)

6. The authorization method according to claim 1, wherein the access token indicates at least one of:
an identity of the first resource;
an identity of the AF;
an expected service name indicating a service authorized to process the first resource; or
an expected service operation name indicating a service operation authorized to process the first resource.

7. The authorization method according to claim 1, further comprising at least one of:
performing identity authentication between the AF, the authorization function, and a network exposure function (NEF);
performing identity authentication between the AF, the authorization function, and a terminal; or
performing identity authentication between the AF, the authorization function, the network exposure function (NEF), and the terminal.

8. The authorization method according to claim 1, further comprising:
sending resource management request information to a network exposure function (NEF),
wherein the resource management request information carries the access token, and is configured to request to authorize the AF to manage the first resource,
wherein the resource management request information further comprises at least one of:
an identity of the AF;
an identity of a terminal;
an identity of the first resource;
a service name indicating a service requested to process the first resource;
a service operation name indicating a service operation requested to process the first resource; or
PIN-related information,
wherein the authorization method further comprises:
receiving resource management response information sent by the NEF,
wherein the resource management response information indicates acceptance or rejection of the resource management request information.

9-10. (canceled)

11. An authorization method which is performed by an authorization function, comprising:
receiving token request information sent by an AF,
wherein the token request information is configured to request an access token, and the access token is configured to authorize the AF to manage the first resource.

12. The authorization method according to claim 11, wherein the token request information comprises at least one of:
an identity of the AF;
an identity of a terminal; or
an identity of the first resource,
wherein the identity of the first resource comprises at least one of:
an identity of a personal IoT network (PIN); or
an identity of core network assistance information.

13. (canceled)

14. The authorization method according to claim 11, further comprising:
sending the access token to the AF,
wherein the access token indicates the first resource.

15. (canceled)

16. The authorization method according to claim 14, wherein sending the access token to the AF comprises at least one of:
sending the access token to the AF based on a predetermined service agreement, wherein the predetermined service agreement is a service agreement between the AF and an operator;
sending the access token to the AF in response to confirmation from a terminal, wherein the confirmation indicates whether the terminal agrees to or rejects the sending the access token; or
sending the access token to the AF based on a local policy of the authorization function.

17. The authorization method according to claim 11, wherein the access token indicates at least one of:
an identity of the first resource;
an identity of the AF;
an expected service name indicating a service authorized to process the first resource; or
an expected service operation name indicating a service operation authorized to process the first resource.

18. The authorization method according to claim 11, further comprising at least one of:
performing identity authentication between the AF, the authorization function, and a network exposure function (NEF);
performing identity authentication between the AF, the authorization function, and a terminal; or
performing identity authentication between the AF, the authorization function, the network exposure function (NEF), and the terminal.

19. The authorization method according to claim 11, wherein the authorization function comprises one of:
a core function of common application programming interface framework (CAPIF);
a network exposure function (NEF); or
a network repository function (NRF).

20. An authorization method which is performed by a NEF, comprising:
receiving resource management request information sent by an AF,
wherein the resource management request information carries an access token, and is configured to request to authorize the AF to manage a first resource.

21. The authorization method according to claim 20, wherein the access token indicates at least one of:
an identity of the first resource;
an identity of a terminal;
an identity of the AF;
an expected service name indicating a service authorized to process the first resource; or
an expected service operation name indicating a service operation authorized to process the first resource,
wherein the identity of the first resource comprises at least one of:
an identity of a personal IoT network (PIN); or
an identity of core network assistance information.

22. The authorization method according to claim 20, wherein the resource management request information further comprises at least one of:
an identity of the AF;
an identity of a terminal;
an identity of the first resource;
a service name indicating a service requested to process the first resource;
a service operation name indicating a service operation requested to process the first resource; or
PIN-related information,
wherein the identity of the first resource comprises at least one of:
an identity of a personal IoT network (PIN); or
an identity of core network assistance information.

23. (canceled)

24. The authorization method according to claim 20, further comprising:
performing integrity verification of the access token in response to receiving the resource management request information,
wherein the authorization method further comprises:
rejecting the resource management request information in response to the integrity verification of the access token failing; or
verifying, in response to the integrity verification of the access token succeeding, the resource management request information based on the access token.

25-26. (canceled)

27. The authorization method according to claim 24, wherein the integrity verification of the access token succeeds, and verifying the resource management request information based on the access token comprises at least one of:
determining whether an identity of the first resource in the access token matches an identity of the first resource comprised in the resource management request information;
determining whether an expected service identity in the access token matches a service identity comprised in the resource management request information; or
determining whether an expected service operation identity in the access token matches a service operation identity comprised in the resource management request information.

28. The authorization method according to claim 24, wherein the integrity verification of the access token succeeds, and the authorization method further comprises:
rejecting the resource management request information in response to the verifying of the resource management request information failing.

29. (canceled)

30. The authorization method according to claim 20, further comprising:
sending resource management response information to the AF,
wherein the resource management response information indicates acceptance or rejection of the resource management request information.

31-36. (canceled)
